(19) United States
(12) Patent Application Publication
(10) Pub. No.: US 2009/0002810 A1
(43) Pub. Date: Jan. 1, 2009

(54) Sheet Type Phosphors, Preparation Method Thereof, And Light Emitting Devices Using These Phosphors

(75) Inventors: Sung-Duk Jeon, Seoul (KR); Jong-Soo Kim, Seoul (KR); Gui-Don Choi, Seoul (KR)

Correspondence Address: VOLPE AND KOENIG, P.C., UNITED PLAZA, SUITE 1600, 30 SOUTH 17TH STREET, PHILADELPHIA, PA, 19103, US

(73) Assignee: LUCIMEA CO., LTD., Seoul (KR)

(21) Appl. No.: 12/161,282

(22) PCT Filed: Jan. 16, 2007
(86) PCT No.: PCT/KR07/00250

§ 371 Date: Jul. 17, 2008

(30) Foreign Application Priority Data
Jan. 17, 2006 (KR) 1020060004760

(51) Int. Cl. F21V 9/06

(52) U.S. Cl. 359/361

(57) ABSTRACT

The present invention relates to a sheet type phosphor used for a light source absorbing blue/near ultraviolet light and emitting visible light, wherein the phosphor is obtained by molding a phosphor alone or a mixture of the phosphor and a light transmissive ceramic material in the shape of a sheet, a preparation method of the phosphor, and a light emitting device using the phosphor. A light emitting device for wavelength conversion manufactured by bonding the sheet type phosphor of the present invention to a light emitting device chip for emitting light from near ultraviolet to blue light induces remarkable reduction of defect rate and manufacturing cost and provides excellent thermal durability and color reproducibility as compared with a conventional light emitting device using phosphor powder. Further, the sheet type phosphor can be applied to a light source for LCD backlight, household lighting or the like.

### TECHNICAL FIELD

The present invention relates to a sheet type phosphor, which is used for a light source for absorbing blue/near ultraviolet light and emitting visible light and is characterized in that the sheet type phosphor is obtained by molding and sintering a phosphor alone or a mixture of a phosphor and an light transmissive ceramic material in the shape of a sheet, a preparation method of the phosphor, and a light emitting device using the phosphor.

### BACKGROUND ART

In a conventional white light emitting device, there has been used a method for inducing white color through a combination of blue color of the LED and yellow color of the phosphor by causing a yellow YAG-based phosphor to be excited by lights with sufficiently high energy emitted from a blue LED of high luminance to emit light in a yellow color range. FIG. 1 shows a structure of a conventional white light emitting device in which a blue LED and a powder type yellow light emitting YAG-based phosphor are employed. However, since the combination of blue light emitted from LED chips and yellow light emitted from the phosphor is very sensitive to coating methods of the phosphor and operating conditions of the LED chips in a conventional light emitting device illustrated in FIG. 1, it is very difficult to reproduce the same white color in a conventional YAG-based white light emitting device. Particularly, as illustrated in FIG. 1, the conventional YAG-based white light emitting device has problems such as irregular luminance, high defect rate of devices and deterioration of color reproducibility owing to a mixing ratio of epoxy resin or silicone resin used for coating a phosphor, thermal instability of these resins, and irregular accumulation of the phosphor during curing.

Therefore, it is required to develop a phosphor with a new structure and a new packaging method in order to get a light emitting device emitting stable white light using a phosphor and a GaN-based blue LED.

### Disclosure

### Technical Problem

An object of the present invention is to provide a light emitting device, which reduces defect rate and manufacturing cost and obtains excellent thermal durability and color reproducibility as compared with a conventional light emitting device using phosphor powder, thus being applied to a light source for LCD backlight, household lighting, or the like, and a preparation method of the light emitting device.

Another object of the present invention is to provide a novel light emitting device in which a sheet type phosphor is bonded to a blue/near ultraviolet LED.

### Technical Solution

In order to achieve the objects, the present invention provides a sheet type phosphor used for a light source absorbing blue/near ultraviolet light and emitting visible light, wherein the phosphor is obtained by molding and sintering a phosphor alone or a mixture of the phosphor and a light transmissive ceramic material in the shape of a sheet.

In addition, the sheet type phosphor may comprise grooves formed on at least any one surface of the sheet type phosphor.

Further, the grooves may be formed in parallel with one another in a direction or across at a right angle in both directions to have a mesh shape.

Furthermore, the light transmissive ceramic material may be at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂, and is mixed in a range from 0 to 60 wt % of the total weight of the sheet type phosphor.

Another aspect of the present invention provides a preparation method of a sheet type phosphor used for a light source absorbing blue/near ultraviolet light and emitting visible light, comprising steps of: i) mixing and milling raw materials for the phosphor; ii) firing the milled mixture at 1,100 to 1,600° C. in a reducing atmosphere to synthesize phosphor powder; iii) milling the primarily fired mixture again; iv) injecting the re-milled phosphor powder into a mold and molding the phosphor powder in the shape of a sheet by applying a pressure to the mold; and v) sintering the molded phosphor at 1,100 to 1,600° C. in a reducing atmosphere.

In addition, the phosphor may be at least one selected from the group consisting of (Ba, Sr, Ca)₂SiO₄:Eu²⁺, YAG((Y, Gd)₃(Al, Ga)₅O₁₂:Ce³⁺)-based phosphor, TAG((Th, Gd)₃(Al, Ga)₅O₁₂:Ce³⁺)-based phosphor, (Ba, Sr, Ca)₃SiO₅:Eu²⁺, (Ba, Sr, Ca)MgSi₂O₆:Eu²⁺, Mn²⁺, (Ba, Sr, Ca)₃MgSi₂O₈:Eu²⁺, Mn²⁺ and (Ba, Sr, Ca)MgSiO₄:Eu²⁺, Mn²⁺.

Further, the preparation method may further comprise the step of adding light transmissive ceramic material to the phosphor before the molding step iv, the light transmissive ceramic material being at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂, the light transmissive ceramic material being added in a range from 0 to 60 wt % of the total weight of the sheet type phosphor.

Furthermore, the preparation method may further comprise the step of forming grooves on at least one surface of the sheet type phosphor after molding step iv) or sintering step v).

Still furthermore, the grooves may be formed in parallel with one another in a direction or across at a right angle in both directions to have a mesh shape.

In order to achieve other objects of the present invention, the present invention provides a light emitting device manufactured by bonding the sheet type phosphor to a blue/near ultraviolet LED.

Hereinafter, the present invention will be described in more detail.

A sheet type phosphor of the present invention, which is used for a light source for absorbing blue/near ultraviolet light and emitting visible light, is characterized in that the sheet type phosphor is obtained by molding and sintering a phosphor alone or a mixture of a phosphor and an light transmissive ceramic material in the shape of a sheet. As described above, a conventional light emitting device of a wavelength conversion type has low thermal and light stability since the conventional light emitting device is manufactured by encapsulating a light emitting diode of light in blue/near ultraviolet regions in epoxy mixed with a phosphor. On the contrary, a sheet type phosphor of the present invention has excellent thermal and light stability and makes it possible to emit light with high luminance. The kind of the phosphor is not particularly limited, but all known phosphors for wavelength conversion can be used. Such a phosphor include one or more phosphors selected from the group consisting of (Ba, Sr, Ca)₂SiO₄:Eu²⁺, YAG((Y, Gd)₃(Al, Ga)₅O₁₂:Ce³⁺)-based phosphor, TAG((Th, Gd)₃(Al, Ga)₅O₁₂:Ce³⁺)-based phosphor, (Ba, Sr, Ca)₃SiO₅:Eu²⁺, (Ba, Sr, Ca)MgSi₂O₆:Eu²⁺, Mn²⁺, (Ba, Sr, Ca)₃MgSi₂O₈:Eu², Mn²⁺ and (Ba, Sr, Ca)MgSiO₄:Eu²⁺, Mn²⁺. In embodiments of the present invention, a phosphor of Sr₂SiO₄:Eu²⁺ or CaMgSi₂O₆:Eu²⁺, Mn²⁺ is used.

The sheet type phosphor of the present invention can be combined with a light emitting diode when the sheet type phosphor is used for converting a wavelength. FIG. 2 is a view showing a structure of a white light emitting device to which a ceramic sheet type phosphor according to the present invention is applied. As illustrated in FIG. 2, a light emitting diode is formed by providing a light emitting diode within a predetermined housing and positioning the sheet type phosphor of the present invention on the light emitting diode. Therefore, while a portion of light emitted from the light emitting diode is emitted after passing through the sheet type phosphor, the other is absorbed into the sheet type phosphor to emit light corresponding to characteristics of the phosphor. A cavity may be formed between the light emitting diode and the sheet type phosphor, and may be filled with other materials in accordance with purposes.

The phosphor sheet can be obtained by molding and sintering a phosphor alone or a mixture of the phosphor and a light transmissive ceramic material. The sheet type phosphor can be prepared by molding and sintering a phosphor alone since a phosphor is also a kind of ceramic, and by molding and sintering a mixture of the phosphor and other ceramic material for securing thermal stability or controlling luminance. The light transmissive ceramic material is particularly limited, and may be any one, which does not react with light having a wavelength region generated from a light emitting diode or phosphor but can transmit visible light in the wavelength range. However, the light transmissive ceramic material is preferably a material which is transparent in a visible light region in order to meet the objects of the present invention, and a preferable example of the light transmissive ceramic material is at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂. Furthermore, the light transmissive ceramic material is preferably added to the phosphor in a range from 0 to 60 wt % of the total weight of the sheet type phosphor. This is because it is undesirable that luminance of light generated from the phosphor is lowered if the light transmissive ceramic material is added over 60 wt % of the total weight of the sheet type phosphor.

Furthermore, it is preferable that grooves be formed on at least one surface of the sheet type phosphor. The grooves serve to increase a surface area of the sheet type phosphor to improve reactivity of the sheet type phosphor with light emitted from a light emitting diode. The grooves can be formed using a known means, such as a diamond wheel or laser, capable of processing a surface of ceramics, and the number or shape of the grooves is not particularly limited. However, for convenience of processing in an embodiment of the present invention, it is preferable that the grooves be formed on at least one surface of the sheet type phosphor in parallel with one another in a direction or across at a right angle in both directions to have a mesh shape.

The sheet type phosphor can be prepared through a process comprising steps of i) mixing and milling raw materials for the phosphor, ii) firing the milled mixture at 1,100 to 1,600° C. in a reducing atmosphere to synthesize phosphor powder, iii) milling the primarily fired mixture again, iv) injecting the re-milled phosphor powder into a mold and molding the phosphor powder in the shape of a sheet by applying a pressure to the mold, and v) sintering the molded phosphor at 1,100 to 1,600° C. in a reducing atmosphere. Since the mixing and milling step of raw materials, the firing and re-milling steps and the like are similar to those in a conventional phosphor preparation method, the details on the foregoing will not be described in more detail herein. According to the preparation method of the sheet type phosphor of the present invention, after the mixing and milling step of raw materials, and the firing and re-milling steps are performed, the steps of injecting phosphor powder into a mold, molding and sintering the phosphor powder are performed, thereby preparing the phosphor in the shape of a sheet. As described above, the sheet type phosphor of the present invention can be molded and sintered together with a light transmissive ceramic material. In such a case, the mixture is molded in the molding step after the light transmissive ceramic material of a desired composition is mixed.

After performing the foregoing steps, the sheet type phosphor can be used as it is in shape, or a processing step may be further performed on the sheet type phosphor. Particularly, since when a sheet type phosphor is required to have a thickness or size of about sub-micron to micron level, it is difficult to maintain the thickness or size of the sheet type phosphor in the molding and sintering steps, the sheet type phosphor with desired shape and size can be obtained by preferentially obtaining a sheet type or bulk type phosphor with predetermined thickness and size and then performing a processing of cutting and/or slicing the sheet type or bulk type phosphor. After performing the processing steps, an additional sintering step for removing contaminants caused by the processing steps may be performed.

Luminance of the sheet type phosphor can be adjusted by thickness and porosity thereof or mixing ratio of a ceramic material. As described above, luminescent characteristics, such as luminance, can be controlled to a certain extent by adjusting geometric shape of the sheet type phosphor of the present invention or adding a light transmissive ceramic material to phosphor powder, and further controlled by adjusting thickness or porosity of the sheet type phosphor. The porosity can be controlled by adjusting sintering time or temperature. Since the foregoing descriptions can be understood by those skilled in the art, the more details thereon will be omitted herein.

Furthermore, the preparation method of the sheet type phosphor of the present invention can additionally include a step of forming grooves on at least one surface of the sheet type phosphor after molding step iv) or sintering step v). As described above, the luminance is further improved when the grooves are formed on a surface of the sheet type phosphor. Although the step of forming the grooves may be performed after the molding or sintering step, or before, in the middle of, or after the additional processing step, the groove forming step is preferably performed after the molding or sintering step in consideration of operation convenience since it is somewhat inconvenient to perform the operation when the grooves are formed in a state where the sheet type phosphor has a small size.

The sheet type phosphor prepared by the foregoing method is bonded onto a light emitting diode with luminescent characteristics of blue/near ultraviolet light to form a light emitting device for wavelength conversion. While a conventional light emitting device is manufactured by encapsulating the light emitting diode with epoxy resin, a light emitting device of the present invention is manufactured by positioning the sheet type phosphor over the light emitting diode such that they are spaced apart from one another by a predetermined distance, wherein the combining method is not particularly limited. That is, the sheet type phosphor can be bonded by a conventional chemical method using adhesive, sealant or the like, or by using a conventional mechanical mounting structure.

### ADVANTAGEOUS EFFECTS

As described above, a sheet type phosphor according to the present invention, as a phosphor for wavelength conversion, is combined with a light emitting device chip for emitting light from near ultraviolet to blue light regions. Thus, it is possible to improve the thermal characteristics which can be deteriorated due to a mixing method of phosphor powder and epoxy or silicone resin used in a conventional light emitting device, to overcome defect rate which can be high when the phosphor is applied, and to reduce the manufacturing cost by simplifying the manufacturing process. Furthermore, it is possible to provide a light emitting device that can be applied to a light source for LCD backlight, household lighting or the like.

The technical spirit of the present invention must not be limited to the embodiment of the present invention described above and illustrated in the drawings. The scope of the present invention should be limited only by the claims. It will be apparent that those skilled in the art can modify and change the technical spirit of the present invention to a variety of forms. Therefore, such modifications and changes will be included in the true scope of the present invention to the extent that such modifications and changes are obvious to those skilled in the art.

### DESCRIPTION OF DRAWINGS

FIG. 1 is a view showing a structure of a conventional white light emitting device to which a blue LED and a powder type yellow light emitting YAG-based phosphor are applied;

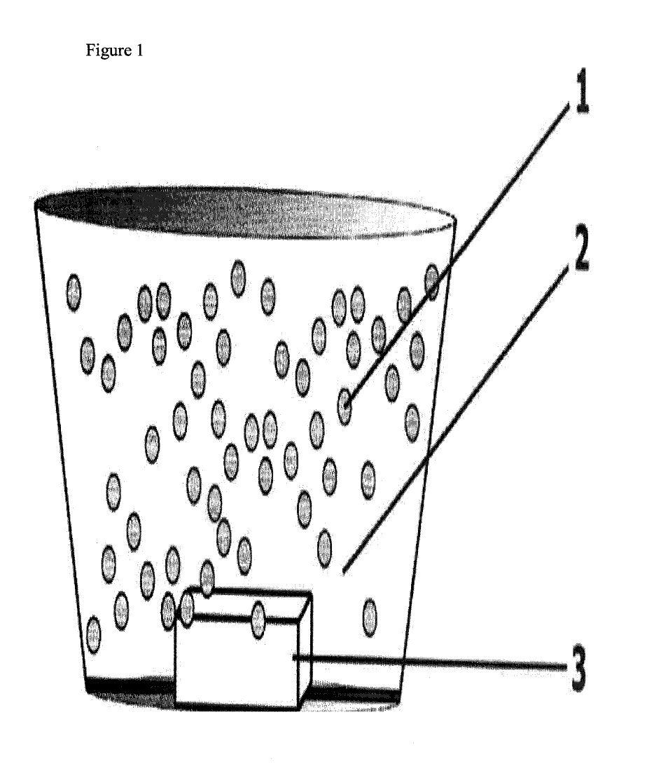

FIG. 2 is a view showing a structure of a white light emitting device to which a ceramic sheet type phosphor according to the present invention is applied;

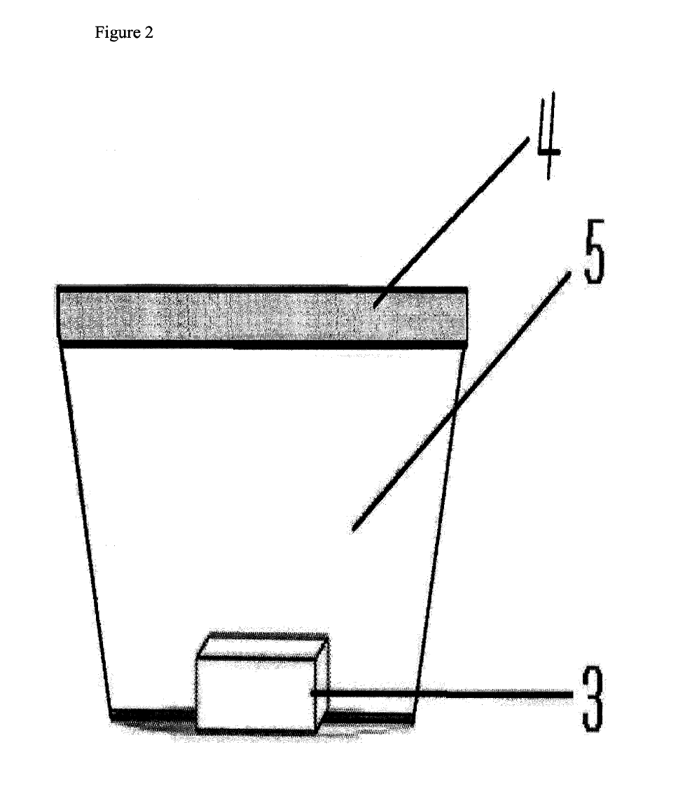

FIG. 3 shows an emission spectrum of a ceramic sheet type blue-based white light emitting diode manufactured with a thickness of 30 μm according to the present invention;

FIG. 4 shows an emission spectrum of a ceramic sheet type blue-based white light emitting diode manufactured with a thickness of 50 μm according to the present invention;

FIG. 5 shows an emission spectrum of a ceramic sheet type blue-based white light emitting diode manufactured with a thickness of 100 μm according to the present invention;

FIG. 6 shows an emission spectrum of a white light emitting device manufactured by combining a ceramic sheet, which is prepared in a preferred embodiment 2-1 and is obtained through a sintering time of 2 hours to have a porosity of 8%, with a blue-based light emitting diode;

FIG. 7 shows an emission spectrum of a light emitting device manufactured by combining a SiO₂, which is mixed sheet type phosphor prepared in a preferred embodiment 4, with a blue light emitting diode;

FIG. 8 shows an emission spectrum of a white light emitting device manufactured by combining a ceramic sheet, which is prepared in a preferred embodiment 2-2 and is obtained through a sintering time of 8 hours to have a porosity of 2%, with a blue-based light emitting diode;

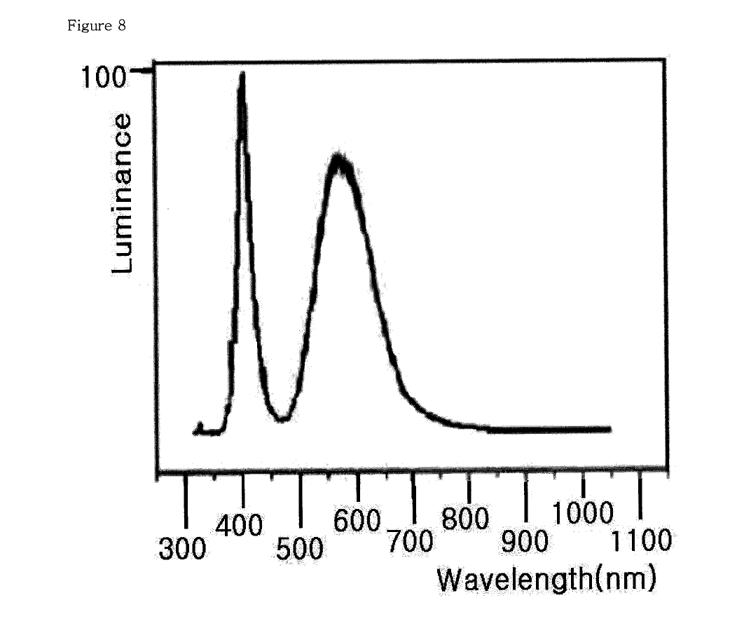

FIG. 9 is a schematic view showing a structure of a light emitting device manufactured by combining a sheet type phosphor according to the present invention, on which grooves are formed, with a blue-based light emitting diode;

FIG. 10 shows an emission spectrum of the light emitting device manufactured by combining the sheet type phosphor according to the present invention, on which grooves are formed, with a blue-based light emitting diode; and

FIG. 11 shows an emission spectrum of a near ultraviolet-based white light emitting diode to which a white light emitting ceramic sheet type phosphor according to the present invention is applied.

### EXPLANATION OF REFERENCE NUMERALS FOR MAJOR PORTIONS SHOWN IN DRAWINGS

| | |
|---|---|
| 1: YAG-based phosphor powder | 2: Epoxy resin |
| 3: Blue LED | 4: Sheet type phosphor |
| 5: Cavity or epoxy resin | |
| 6: Sheet type phosphor with | |
| groove formed | |
| 7: Near ultraviolet LED | 8: White flat sheet type phosphor |

### Best Mode

Hereinafter, the present invention will be described in more detail through preferred embodiments of the present invention. However, the follow embodiments are provided to aid understanding of the present invention, the present invention is not limited only to the follow embodiments.

### Preferred Embodiment 1-1

### Sheet Type Phosphor and Manufacture of White Light Emitting Device Using the Same

After weighing strontium carbonate (SrCO₃), silica (SiO₂) and europium oxide (Eu₂O₃) to a desired composition and putting the weighed materials into a container, the weighed materials were mixed and milled by ball milling for 24 hours. The milled mixture was fired at 1,250° C. for 4 hours in an electric furnace of a mixed gas atmosphere with 5% of the ratio of hydrogen to nitrogen mixing (H₂/N₂) to Synthesize Sr₂SiO₄:Eu²⁺ phosphor powder. Thereafter, the fired phosphor was milled again for 24 hours by ball milling. After putting about 30 grams of the re-milled fired phosphor powder into a disk-shaped metal mold with a diameter of 5 cm and a thickness of 5 mm, the re-milled fired phosphor powder was compressed by a pressure of 700 kg/cm² for 2 hours to mold a disk-shaped phosphor with a diameter of 5 cm and a thickness of 5 mm. The molded disk was sintered at 1,300° C. for 4 hours in an electric furnace of a mixed gas atmosphere with 5% of the ratio of hydrogen to nitrogen mixing (H₂/N₂) to manufacture a sheet type phosphor.

The phosphor manufactured as above is processed to have a width of 5 mm, a length of 5 mm and thickness of 30 μm using a diamond wheel. The processed sheet type phosphor was sintered at 1,250° C. for one hour in an electric furnace of a mixed gas atmosphere with 5% of the ratio of hydrogen to nitrogen mixing (H₂/N₂) to remove residues of lubricant or water used in the cutting process. The sheet type phosphor prepared as above was bonded to an upper end of a GaN-based light emitting diode having blue light emitting characteristics, thus manufacturing a white light emitting device.

### Preferred Embodiment 1-2

### Sheet Type Phosphor and Manufacture of White Light Emitting Device Using the Same

A sheet type phosphor and a light emitting device were manufactured in the same manner as in the preferred embodiment 1-1 except that the sheet type phosphor had a thickness of 50 μm.

### Preferred Embodiment 1-3

### Sheet Type Phosphor and Manufacture of White Light Emitting Device Using the Same

A sheet type phosphor and a light emitting device were manufactured in the same manner as in the preferred embodiment 1-1 except that the sheet type phosphor had a thickness of 100 μm.

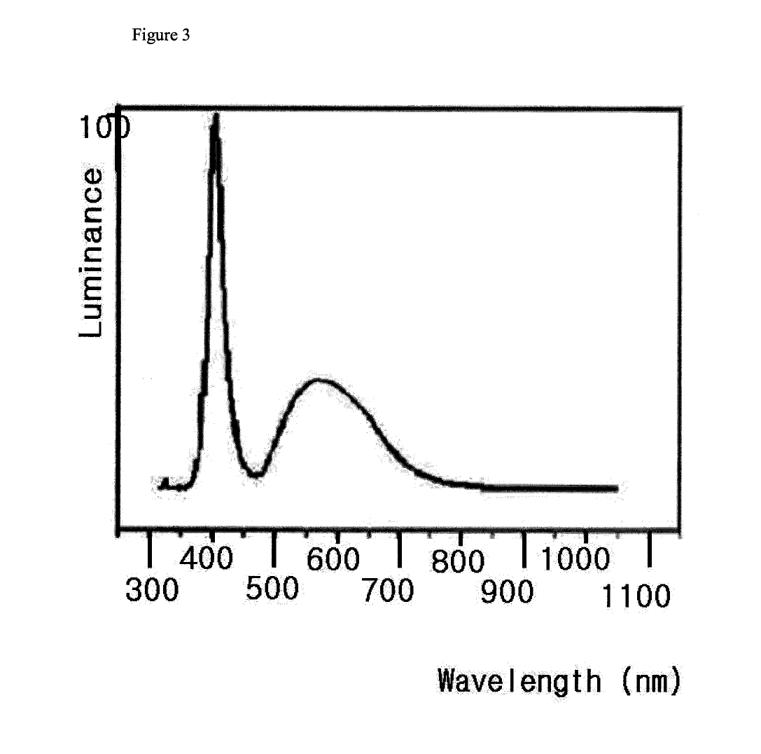

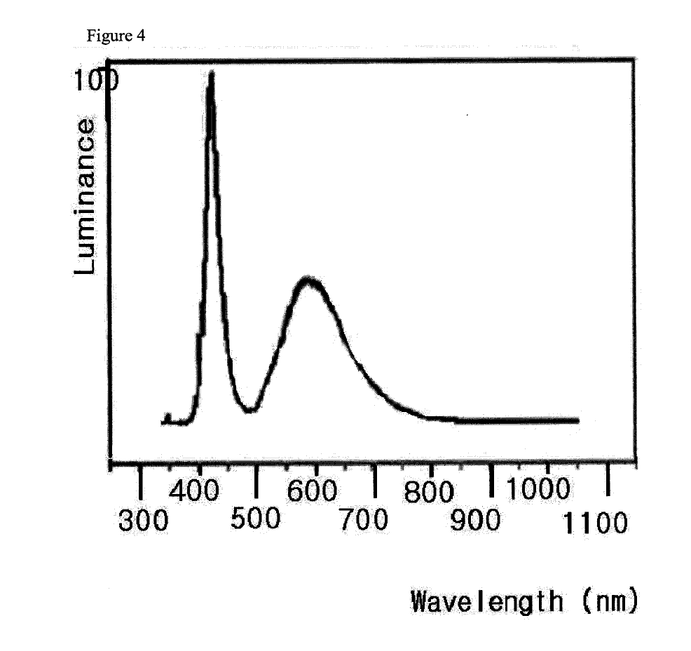

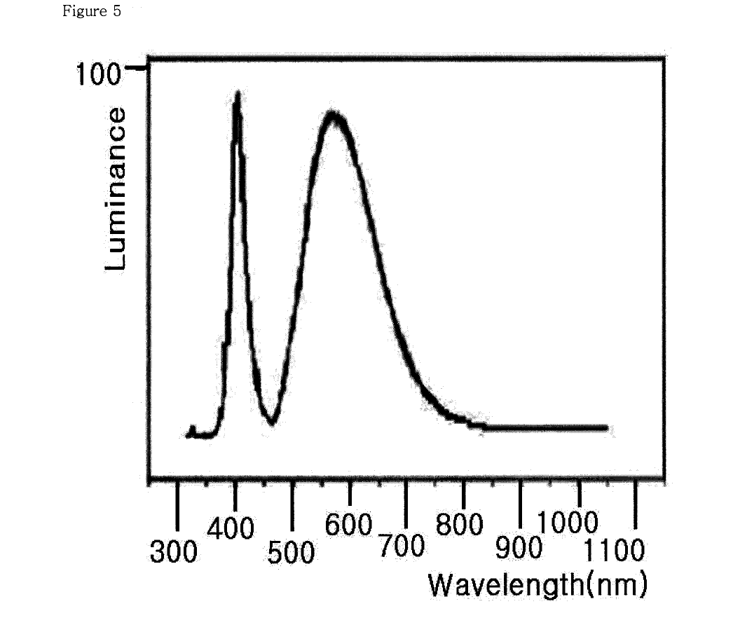

FIGS. 3 to 5 shows emission spectrums of white light emitting devices manufactured by respectively combining the sheet type phosphors having thickness of 30, 50 and 100 μm prepared in the preferred embodiments 1-1 to 1-3 with an upper end of a GaN-based light emitting diode having a blue light emitting characteristic. In the emission spectrums, an emission peak at 460 nm is an emission peak of a blue light emitting GaN diode, and an emission peak at 560 nm is an emission peak caused by the transition of electrons from f-orbit to d-orbit of Eu²⁺ of the sheet type phosphor. As illustrated in FIGS. 3 to 5, the ceramic sheet type phosphor with a thickness of 50 μm shows an optimal white color and exhibits a pure white color coordinate of x=0.3 and y=0.3. On the other hand, it can be seen that an emission peak of the blue light emitting GaN diode at 460 nm is relatively decreased in a sheet type phosphor with a thickness of 100 μm since an amount of light emission of the blue light emitting GaN diode, which is absorbed into the sheet type phosphor is increased as the thickness of the sheet type phosphor, is increased. Meanwhile, it can be seen that an emission peak of the blue light emitting GaN diode at 460 nm is relatively increased in a sheet type phosphor with a thickness of 30 μm since an amount of light emission of the blue light emitting GaN diode, which is absorbed into the sheet type phosphor decreases when thickness of the sheet type phosphor, is decreased.

### Preferred Embodiment 2-1

### Light Emitting Characteristic Depending on Porosity of Sheet Type Phosphor

A sheet type phosphor and a light emitting device were manufactured in the same manner as in the preferred embodiment 1-2 except that the molded sheet type phosphor was sintered for 2 hours.

### Preferred Embodiment 2-2

### Light Emitting Characteristics Depending on Porosity of Sheet Type Phosphor

A sheet type phosphor and a light emitting device were manufactured in the same manner as in the preferred embodiment 1-2 except that the molded sheet type phosphor was sintered for 8 hours.

The following Table 1 shows measurement results of porosity of a sheet type phosphor according to sintering time.

TABLE 1

| Sintering time (hours) | Porosity |
|---|---|
| 2 | 8% |
| 4 | 5% |
| 8 | 2% |

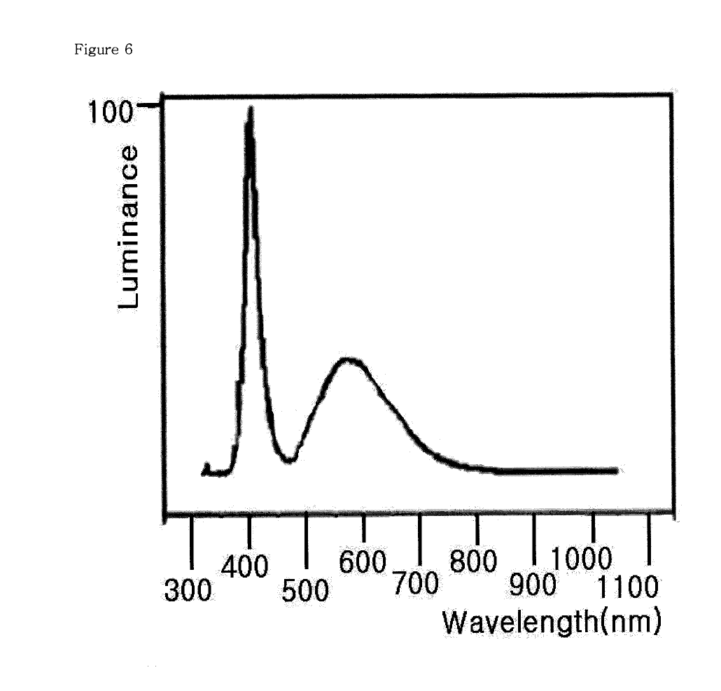

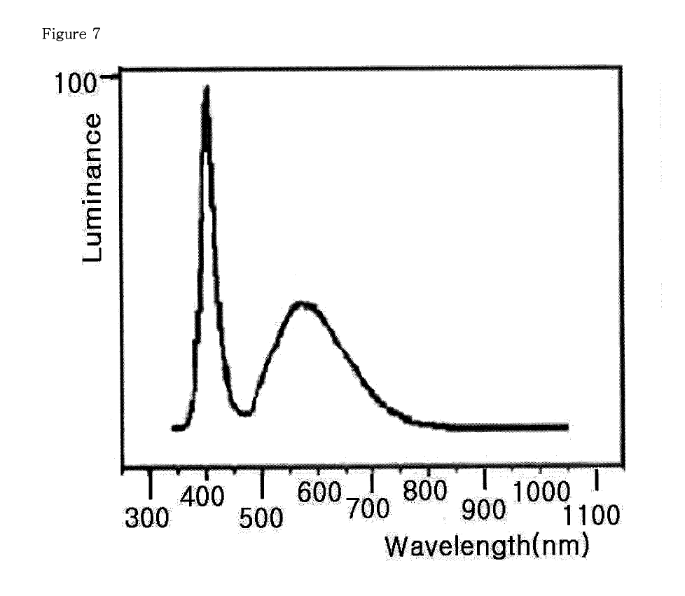

As can be seen from Table 1, if the sintering time is increased, the porosity is decreased. FIGS. 6 and 7 respectively show an emission spectrum of the white light emitting device manufactured by combining the ceramic sheet, which is prepared through a sintering time of 2 hours according to the preferred embodiment 2-1 with have a porosity of 8%, to a blue-based light emitting diode, and an emission spectrum of the white light emitting device manufactured by combining the ceramic sheet, which is prepared through a sintering time of 8 hours according to the preferred embodiment 2-2 to have a porosity of 2%, with a blue-based light emitting diode. It can be seen from the emission spectrums that an emission peak of the blue light emitting GaN diode at 460 nm is relatively increased in the ceramic sheet type phosphor prepared through a sintering time of 2 hours, and an emission peak of the blue light emitting GaN diode at 460 nm is relatively decreased in the ceramic sheet type phosphor prepared through a sintering time of 8 hours. This is because an amount of light emission of the blue light emitting GaN diode absorbed into a sheet type phosphor is increased according as pores of the ceramic sheet type phosphor are reduced.

### Preferred Embodiment 3

### Manufacture of Sheet Type Phosphor Having Grooves Formed on Surface Thereof and Light Emitting Device

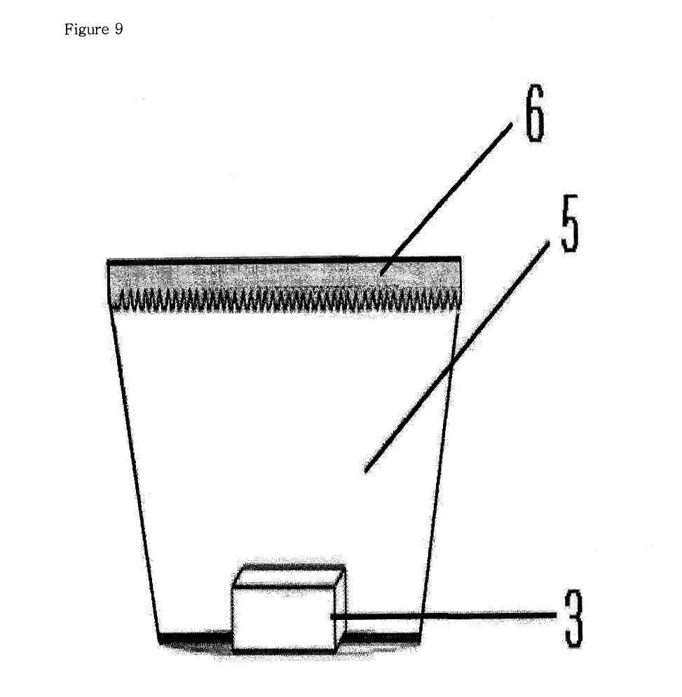

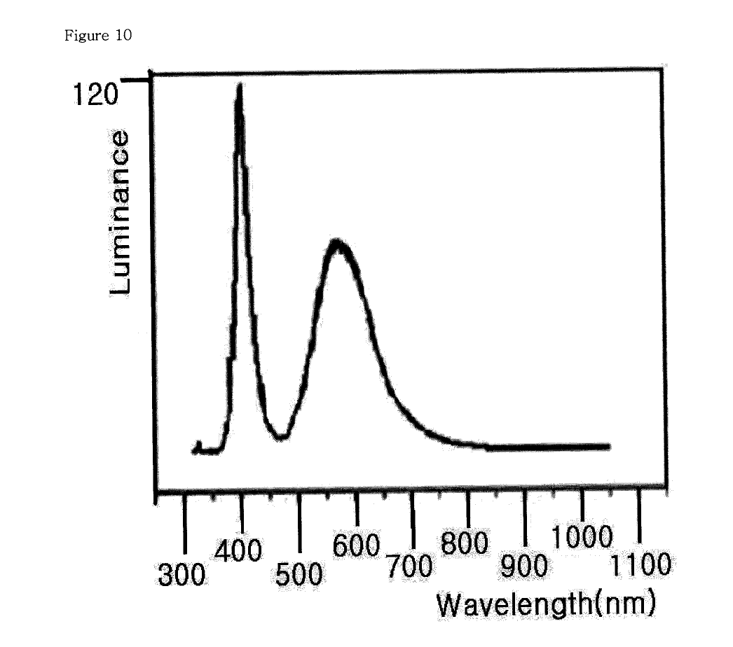

Grooves were formed on one surface of the sheet type phosphor prepared in the preferred embodiment 1-2 by means of a diamond wheel or laser beam so that the grooves were spaced apart from one another by a gap of 0.5 μm. A white light emitting device was manufactured by bonding the prepared sheet type phosphor having the grooves formed to a GaN-based light emitting diode having blue light emitting characteristics. FIG. 9 is a schematic view showing a structure of a light emitting device manufactured by bonding a sheet type phosphor according to the present invention, on which grooves are formed, to a blue-based light emitting diode. FIG. 10 shows an emission spectrum of the light emitting device manufactured by bonding the sheet type phosphor according to the present invention, on which grooves are formed, to a blue-based light emitting diode. As illustrated in FIG. 10, it can be seen that the sheet type phosphor having the grooves formed has an increased luminance as compared with the sheet type phosphor of the preferred embodiment 1-2. It is supposed that this is because the grooves increase a light contact area to cause a larger amount of blue light of GaN to be absorbed into the ceramic sheet type phosphor.

### Preferred Embodiment 4

### Preparation of Sheet Type Phosphor to which Ceramic Material is Added

A sheet type phosphor and a light emitting device were manufactured in the same manner as in the preferred embodiment 1-2 except that 20 wt % of SiO₂ powder was added to the phosphor powder in the molding step. FIG. 7 shows an emission spectrum of a light emitting device manufactured by bonding sheet type phosphor prepared in a preferred embodiment 4, to a blue light emitting diode. It can be seen from FIG. 7 that an emission density of a ceramic phosphor is decreased in a visible light range by transparent SiO₂ in the sheet type phosphor with SiO₂ contained. That is, due to the addition of SiO₂, an emission peak of the blue light emitting GaN diode is relatively increased to obtain a spectrum similar to that of FIG. 6. This suggests that density of the phosphor can be controlled by content change of SiO₂.

### Preferred Embodiment 5

### Preparation of White Light Emitting Sheet Type Phosphor Excited by Near Ultraviolet Light

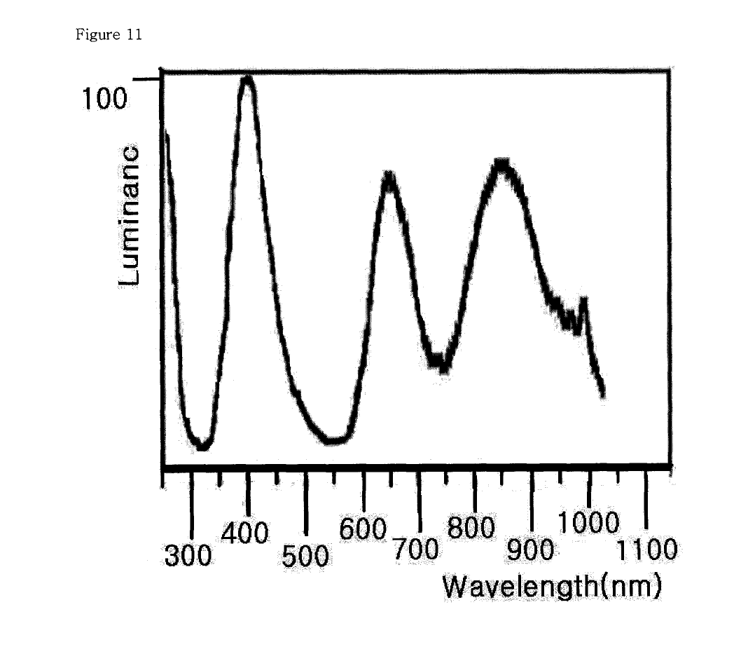

A sheet type phosphor was prepared in the same manner as in the preferred embodiment 1-2 except that as a phosphor powder, CaMgSi₂O₆:Eu²⁺, Mn²⁺ is used which absorbing light in a near ultraviolet light range to emit white light. A white light emitting device was manufactured by bonding the prepared white light emitting sheet type phosphor to an InGaN-based light emitting diode that emits near ultraviolet light. FIG. 11 shows an emission spectrum of a near ultraviolet-based white light emitting diode to which a white light emitting ceramic sheet type phosphor according to the present invention is applied. It can be seen from FIG. 11 that a spectrum of near ultraviolet light is not shown, a blue light emission peak at 460 nm due to Eu²⁺ and emission peaks at 580 nm and 680 nm due to Mn²⁺ are shown, and a white light emitting spectrum with a color coordinate of x=0.28 and y=0.38 is shown.

1. A sheet type phosphor used for a light source absorbing blue/near ultraviolet light and emitting visible light,
wherein the phosphor is obtained by molding and sintering a phosphor alone or a mixture of the phosphor and a light transmissive ceramic material in the shape of a sheet.

2. The sheet type phosphor as claimed in claim 1, comprising grooves formed on at least any one surface of the sheet type phosphor.

3. The sheet type phosphor as claimed in claim 2, wherein the grooves are formed in parallel with one another in a direction or across at a right angle in both directions to have a mesh shape.

4. The sheet type phosphor as claimed in claim 1, wherein the light transmissive ceramic material is at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂, and is mixed in a range from 0 to 60 wt % of the total weight of the sheet type phosphor.

5. A preparation method of a sheet type phosphor used for a light source absorbing blue/near ultraviolet light and emitting visible light, comprising steps of:
i) mixing and milling raw materials for the phosphor;
ii) firing the milled mixture at 1,100 to 1,600° C. in a reducing atmosphere to synthesize phosphor powder;
iii) milling the primarily fired mixture again;
iv) injecting the re-milled phosphor powder into a mold and molding the phosphor powder in the shape of a sheet by applying a pressure to the mold; and
v) sintering the molded phosphor at 1,100 to 1,600° C. in a reducing atmosphere.

6. The preparation method as claimed in claim 5, wherein the phosphor is at least one selected from the group consisting of (Ba, Sr, Ca)₂SiO₄:Eu²⁺, YAG((Y, Gd)₃(Al, Ga)₅O₁₂:Ce³⁺)-based phosphor, TAG((Tb, Gd)₃(Al, Ga)₅O₁₂:Ce³⁺)— based phosphor, (Ba, Sr, Ca)₃SiO₅:Eu²⁺, (Ba, Sr, Ca)MgSi₂O₆:Eu²⁺, Mn²⁺, (Ba, Sr, Ca)₃MgSi₂O₈:Eu²⁺, Mn²⁺ and (Ba, Sr, Ca)MgSiO₄:Eu²⁺, Mn²⁺.

7. The preparation method as claimed in claim 5, further comprising the step of adding light transmissive ceramic material to the phosphor before the molding step iv, the light transmissive ceramic material being at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂, the light transmissive ceramic material being added in a range from 0 to 60 wt % of the total weight of the sheet type phosphor.

8. The preparation method as claimed in claim 5, further comprising the step of forming grooves on at least one surface of the sheet type phosphor after molding step iv) or sintering step v).

9. The preparation method as claimed in claim 8, wherein the grooves are formed in parallel with one another in a direction or across at a right angle in both directions to have a mesh shape.

10. A light emitting device manufactured by combining the sheet type phosphor of claim 1 with a blue/near ultraviolet LED.

11. The preparation method as claimed in claim 6 further comprising the step of adding light transmissive ceramic material to the phosphor before the molding step iv, the light transmissive ceramic material being at least one selected from the group consisting of MgO, CaO, SrO, BaO, SiO₂, GeO₂, SiN, SiAlON, Si₃N₄, Al₂O₃, Ga₂O₃, Y₂O₃, TiO₂, ZrO₂, CeO₂, Sm₂O₃, BaTiO₃, BaTa₂O₆, Ta₂O₃, Sr(Zr, Ti)O₃, PbTiO₃, WO₃, V₂O₃ and In₂O₃—SnO₂, the light transmissive ceramic material being added in a range from 0 to 60 wt % of the total weight of the sheet type phosphor.

12. A light emitting device manufactured by combining the sheet type phosphor of claim 2 with a blue/near ultraviolet LED.

13. A light emitting device manufactured by combining the sheet type phosphor of claim 3 with a blue/near ultraviolet LED.

14. A light emitting device manufactured by combining the sheet type phosphor of claim 4 with a blue/near ultraviolet LED.
